(19) United States
(12) Patent Application Publication
(10) Pub. No.: US 2015/0193850 A1
(43) Pub. Date: Jul. 9, 2015

(54) NETWORK-BASED SERVICE MATCHING

(71) Applicant: Gil TAMIR, Tel Aviv (IL)

(72) Inventor: Gil TAMIR, Tel Aviv (IL)

(21) Appl. No.: 14/147,597

(22) Filed: Jan. 6, 2014

(51) Int. Cl. G06Q 30/06; G06F 17/28

(52) U.S. Cl. CPC G06Q 30/0623; G06F 17/28

(57) ABSTRACT

A method for matching one or more language transforming service providers to a consumer of a requested language transforming service includes receiving by a server via a communication network from the consumer a document for language transforming and a description of the requested language transforming service. One or a plurality of candidates for performing the language transforming service on the document are retrieved by the server from a database of registered language transforming service providers based on professional language transforming skills of each of the candidates with respect to the described requested language transforming service. The retrieved candidates are caused to be presented on a device of the consumer for selection by the consumer.

### FIELD OF THE INVENTION

The present invention relates to network-based matching of a service provider to a service consumer.

### BACKGROUND OF THE INVENTION

Various services and products are offered for hire and sale via the Internet. A potential customer interested in purchasing the service or product is often interested in comparing prices and delivery times from the various providers. The customer may search the Internet for providers of the desired product or service. In many cases, websites exist that enable the customer to directly compare various providers of the service or product. Often, the comparison is limited to providers that have registered or otherwise established a connection with the organization that maintains the website.

In the case of a product, it may be a simple matter to compare prices. A product may often be completely characterized by a few parameters, such as brand, model, size, color, or quantity. In this case, prices may be directly compared. Websites and other channels (e.g., print versions of newspapers, newsletters, magazines) and services (e.g., consumer protection organizations) exist to facilitate comparing prices. These other service may also provide ratings of the various products, vendors, or both.

Some services are also well defined, and vendors of such services may be readily compared. For example, many repair and maintenance jobs may be standardized with respect to the work requested. Vendors of such services may offer a fixed price, and a time required or requested for performance of the service may be stated in advance. In such a case, prices charged for performance of the service by various vendors may be directly compared. Airplane and other travel fares, hotels, restaurants, and other travel-related services may also be readily compared. Similarly, insurance policies to insure a particular article (vehicle, building or apartment, property) or against a particular circumstance (death, illness, disaster) can also be directly compared.

Other services may be more difficult to compare. With many services, it is difficult to estimate the difficulty or the extent of the work in advance. Such services may include language-based services, such as translation, transcription, editing, technical writing, and typing, as well as other services such as programming, planning, and graphic design. Rates for such services are often quoted on the basis of the final product (e.g., per word, line, or page), or on the basis of time required to produce the final result.

A consumer in need of a service may locate a service provider via a bulletin board, either actual, in print, or virtual (e.g., a website). Such a bulletin board may list a pricing rate, and perhaps some promotional statements originating from the service provider. Outside information or recommendations regarding the quality of the service provider's work, or of the ability of the service provider to meet a deadline, may be available from other sources (e.g., by discussion with other consumers of the service, either in an online forum or via word of mouth or private correspondence, or via references listed by the service provider).

Another possibility is for a service consumer to contact an agency that provides the service. The agency may then approach an individual service provider to actually provide the service. The individual service provider may be a member of a pool of freelance service providers or subcontractors, or may be an employee of the agency. The agency typically charges a fee for the service that is substantially higher than the payment that is made to the individual service provider. Although the agency may be aware of the strengths and weaknesses of each individual service provider, such information is not generally made available to the service consumer. Indeed, there may be no direct contact at all between the service consumer and the individual service provider.

### SUMMARY OF THE INVENTION

There is thus provided, in accordance with some embodiments of the present invention, a method for matching one or more language transforming service providers to a consumer of a requested language transforming service, the method including: receiving by a server via a communication network from the consumer a document for language transforming and a description of the requested language transforming service; retrieving by the server from a database of a plurality of registered language transforming service providers one or a plurality of candidates for performing the language transforming service on the document, based on professional language transforming skills of each of the candidates with respect to the described requested language transforming service; and causing the retrieved one or a plurality of candidates to be presented on a device of the consumer for selection by the consumer.

Furthermore, in accordance with some embodiments of the present invention, the professional language transforming skills include a professional language transforming skill selected from a group of professional language transforming skills consisting of a language known, mother tongue, field of expertise, level of education, length of experience, quantity of experience, accuracy of results, and a rate of rendering the requested service.

Furthermore, in accordance with some embodiments of the present invention, the requested service includes translation of the document from an original language to a target language.

Furthermore, in accordance with some embodiments of the present invention, retrieving from the database includes retrieving those candidate service providers that are indicated in the database as being familiar with the original language, the target language, or a subject matter of the document.

Furthermore, in accordance with some embodiments of the present invention, causing the retrieved one or a plurality of candidates to be presented on the device includes causing to be presented a price for providing the requested service by a candidate of the one or a plurality of candidates.

Furthermore, in accordance with some embodiments of the present invention, the price is calculated based on a number of characters, words, lines, or pages in text content of the document, or a length of audio content of the document.

Furthermore, in accordance with some embodiments of the present invention, the price is calculated based on a discount or surcharge.

Furthermore, in accordance with some embodiments of the present invention, causing the retrieved one or a plurality of candidates to be presented on the device includes causing to be presented a projected time of completion of the service by a candidate of the one or a plurality of candidates.

Furthermore, in accordance with some embodiments of the present invention, the projected time of completion is calculated using a speed of providing the service that is determined in accordance with monitored past performance of the candidate.

Furthermore, in accordance with some embodiments of the present invention, the projected time of completion is calculated in accordance with an availability of the candidate.

Furthermore, in accordance with some embodiments of the present invention, causing the retrieved one or a plurality of candidates to be presented on the device includes causing to be presented a score indicative of a suitability of a candidate of the one or a plurality of candidates to provide the requested service.

Furthermore, in accordance with some embodiments of the present invention, the score is calculated in accordance with a rating of previous services that were provided by the candidate.

Furthermore, in accordance with some embodiments of the present invention, the method further includes receiving from the consumer an indication of selection of a candidate of the one or a plurality of candidates to provide the requested service, sending the selected candidate a request to provide the requested service, and receiving from the selected candidate an agreement to or a rejection of the request.

Furthermore, in accordance with some embodiments of the present invention, the method further includes monitoring progress in providing the requested service by the selected candidate.

Furthermore, in accordance with some embodiments of the present invention, the method further includes soliciting from the consumer a rating of the provided service.

Furthermore, in accordance with some embodiments of the present invention, the method further includes causing an indication of the requested service to be presented on a device of a candidate of the one or a plurality of candidates.

There is further provided, in accordance with some embodiments of the present invention, a system for matching one or more language transforming service providers to a consumer of a requested language transforming service, the system including: a processor configured to communicate via a communication network with a device of the consumer, the processor in communication with a computer readable medium, wherein the computer readable medium contains a set of instructions wherein the processor is designed to carry out the set of instructions to: receive from the device of the consumer a document for language transforming and a description of the requested language transforming service; retrieve from a database of a plurality of registered language transforming service providers one or a plurality of candidates for performing the requested language transforming service on the document, based on professional language transforming skills of each of the candidates with respect to the described requested language transforming service; and cause the retrieved one or a plurality of candidates to be presented on the device of the consumer for selection by the consumer.

Furthermore, in accordance with some embodiments of the present invention, the processor is further configured to communicate via the communication network with a device of each of said one or a plurality of candidates, and is further designed to carry out the set of instructions to: receive from the device of the consumer an indication of selection of a candidate of said one or a plurality of candidates to provide the requested service; send the device of the selected candidate a request to provide the requested service; receive from the device of the selected candidate an agreement to or a rejection of the request; monitor progress in providing the requested service by the selected candidate; solicit from the device of the consumer a rating of the provided service; and cause an indication of the requested service to be presented on the device of each candidate of said one or a plurality of candidates.

Furthermore, in accordance with some embodiments of the present invention, the instructions to cause the retrieved one or a plurality of candidates to be presented on the device include causing to be presented a price for providing the requested service by a candidate of said one or a plurality of candidates, an projected time of completion of the service by a candidate of said one or a plurality of candidates, or a score indicative of a suitability of a candidate of said one or a plurality of candidates to provide the requested service.

Furthermore, in accordance with some embodiments of the present invention, the professional language transforming skills include a professional language transforming skill selected from a group of professional language transforming skills consisting of a language known, mother tongue, field of expertise, level of education, length of experience, quantity of experience, accuracy of results, and a rate of rendering the requested service.

### BRIEF DESCRIPTION OF THE DRAWINGS

In order to better understand the present invention, and appreciate its practical applications, the following Figures are provided and referenced hereafter. It should be noted that the Figures are given as examples only and in no way limit the scope of the invention. Like components are denoted by like reference numerals.

FIG. 1 schematically illustrates a system for network-based service matching, in accordance with an embodiment of the present invention.

FIG. 2 schematically illustrates a server of a system for network-based service matching, in accordance with an embodiment of the present invention.

FIG. 3 is a flowchart depicting a method for network-based service matching, in accordance with an embodiment of the present invention.

### DETAILED DESCRIPTION OF THE INVENTION

In the following detailed description, numerous specific details are set forth in order to provide a thorough understanding of the invention. However, it will be understood by those of ordinary skill in the art that the invention may be practiced without these specific details. In other instances, well-known methods, procedures, components, modules, units and/or circuits have not been described in detail so as not to obscure the invention.

Embodiments of the invention may include an article such as a computer or processor readable medium, or a computer or processor storage medium, such as for example a memory, a disk drive, or a USB flash memory, encoding, including or storing instructions, e.g., computer-executable instructions, which when executed by a processor or controller, carry out methods disclosed herein.

In accordance with embodiments of the present invention, a network-based service matching enables a service consumer to select a service provider. Typically, a network-based service matching system is maintained by a service or organization via a website or otherwise via a network or the Internet. Network-based service matching is typically provided for a particular type of service (e.g., document translation, speech transcription, computer programming, or another type of service).

In particular, network-based service matching may be applied to a language transforming service. As used herein, a language transforming service refers to a service in which verbal content that is expressed in one form is transformed to another form. In particular, a language transforming service refers to translation of verbal content in one language to another language, or to transcription of visual or audible verbal content to text (e.g., in alphanumeric characters, pictographs, or other characters).

A language transforming service is performed on an input document. As used herein, a document refers to a representation of alphanumeric text (or other characters), audio content (e.g., spoken speech, audible Morse code, or other audible content), or video content (e.g., of sign language, of a mouth for the purpose of lip reading, semaphore signals, or other visible representation of language), or another electronic or digital file containing a representation of content regarding which a service is requested. The representation is typically digital, especially when intended for transmission over an electronic communications network.

A service consumer, as used herein, may refer to an individual or organization that requires, or may benefit from, a service that is provided by an appropriate service provider. Within the framework of network-based service matching, the service consumer interacts with a network-based service matching organization or server via a network. The service consumer accesses the network via a suitable fixed or mobile device, such as a computer, smartphone, mobile phone, terminal, or other device.

A service provider, as used herein, may refer to an individual or organization that provides one or more services that may be matched to the requirements of a service consumer. Within the framework of network-based service matching, the service provider interacts with a network-based service matching organization or server via a network. The service provider accesses the network via a suitable fixed or mobile device, such as a computer, smartphone, mobile phone, terminal, or other device. The service may be provided by operation of the same device, or of a different (e.g., offline) device. Typically, but not necessarily, a result or product of the service is provided to the serviced consumer via a network.

A description of a service requested is received from the service consumer, e.g., by a server configured for network-based service matching, or by a processor associated with a network-based service matching system. The description may include a specification of the service to be provided. For example, the description may include a document and a description of the service to be provided with respect to the document (e.g., translation from one specific language into another, or editing). As another example, the description may include an audio file containing verbal content to be transcribed, or a specification of a specification of content for computer programming or graphic design. The description may include other relevant information, such as a deadline for a receiving the finished result or any budgetary constraints (e.g., maximum price). In the case of a document or verbal content, the description may specify a field of the subject matter of the document, e.g., selected from a list of fields or entered by the consumer, or automatically detected on the basis of a statistical analysis of content of the document of verbal content.

A database of service providers is maintained. Service providers that are included in the database may be limited to service providers who have registered or subscribed to a network-based service matching organization. Alternatively or in addition, service providers may be included in the database as a result of automatic searching for service providers (e.g., via websites that list service providers, or via employment or headhunting services), or incorporation from other lists of service providers.

The database includes information that is associated with each service provider and that may be utilized in network-based service matching. Such information may include, for example, a unit price for service provided by each service provider (e.g., rate per translated or transcribed word, special rates for exceptional jobs, or other pricing-related information), a specialty or area of expertise (e.g., languages translated or transcribed; mother tongue; subject matter for translation, editing, transcription; programming languages; or other types of specialty or expertise), experience (e.g., provided by the service provider or determined from monitoring services rendered by the service provider), data related to turnaround time (e.g., determined from monitoring previous jobs performed or provided by the service provider), an indication of availability of the service provider (e.g., as provided by the service provider when registering with a network-based service matching organization, or extracted from past performance by the service provider), an indication of quality of work by the service provider (e.g., extracted from feedback provided by previous clients of the service provider), billing-related information (e.g., an account into which payment is to be transferred, tax identification number, currency, information for inclusion on an invoice or receipt), geographical information (e.g., address, time zone), or other information. When entering information into the database, validity of information may be automatically checked for consistency and reasonableness.

On the basis of the received description of the requested service, one or more candidate service providers, and their associated data, may be retrieved from the database. The database may be queried to identify suitable candidate service providers in the database. For example, in the case of a document translation, the database may be queried to identify those translators who are familiar with the document language and the language into which the document is to be translated, and who are familiar with the subject matter of the document.

On the basis of data retrieved from the database and the received description of the requested service, various quantities may be calculated that provide information to enable the consumer to select among a plurality of retrieved candidate service providers.

A price that would be charged by each candidate service provider may be calculated. For example, in the case of document translation, the price is typically determined by the number of words in the document after translation. In this case, the price calculation may include counting the number of words in the original (un-translated) document, using a standard conversion factor or algorithm to estimate the number of words in the final (translated) document, and multiplying by a unit price or rate that is charged by each candidate translator. The price estimate may also take into account other factors, such as discounts or surcharges for particular types of documents or jobs (e.g., minimum charges for small jobs, large jobs, rushed jobs, weekend or holiday work, extended contracts), or other factors that may affect the price (e.g., taxes or currency exchange rates).

A projected time for completion of the requested service by each candidate service provider may be calculated. The calculation of the projected time is based, at least in part, on an expected rate or speed of providing the service by each service provider, an availability of the service provider, and a size of a document to which the service is to be applied. The expected rate may be based on information provided by the candidate service provider, on monitoring of a previous work by that candidate service provider, or both. For example, a network-based service matching system may record when a service provider has started and completed each job that is assigned via the network-based service matching system. An average rate or speed of progress (e.g., pages per hour or per day) may be calculated for that service provider. A more exact estimate may be made if the network-based service matching system enables the service provider to indicate actual time working on the job (e.g., the service provider indicating a start and end time of each period or session of working on the job, similar to punching in or out on a workplace time clock, or by requiring a document or file to be checked out at the beginning of a work session prior and to checked in at the end of the work session). The database may also include a work schedule for each service provider that indicates days or hours during which each service provider is available for work via the network-based service matching system.

A rating of the service provider may be retrieved from the database. For example, consumers who utilize services of the service provider via the network-based service matching system may be requested to rate the product of the service that was received. Where possible, objective criteria may be applied to the product of the service.

Other information that may be relevant to determining the suitability of each candidate service provider may also be retrieved or calculated. For example, information may indicate a level of the professional language transforming skills of each service provider. Professional language transforming skills may include a set of factors or indications of capability of a candidate service provider to provide a particular language transforming service. Such factors or indications may include one or more of languages known, mother tongue, areas or fields of knowledge or expertise, level of education, level of education in a field of expertise, length (e.g., years) of experience in the field of expertise, quantity of experience (quantity of previous work in providing the service, e.g., in an appropriate unit such as pages translated or transcribed), length of experience in providing the requested service, age, accuracy of service results, rate or speed of rendering the requested service, or other indication of professional language transforming skills of the service provider.

The information related to various candidate service providers may then be provided to a service consumer who requires a service. The service consumer may then select a candidate service provider to render the service. The selected service provider is informed, and is sent a specification of the service to be rendered (e.g., including any data or files required, expected or required completion date, pricing limitations or ceilings, or any special instructions). The service provider may agree or decline to render the service. If the service provider agrees to render the service, the network-based service matching system may monitor or assist in satisfying both the service provider and the service consumer (e.g., monitoring work done and assisting or handling billing and payment transfer). If the service provider declines to provide that service, the service consumer may be requested to select an alternate service provider (or may be requested when making the first selection, to select one or more alternate service providers).

Network-based service matching in accordance with some embodiments of the present invention may be advantageous. For example, network-based service matching may provide advantages of both acquiring a service via an agency or company that provides a service (e.g., a translation company that is hired by a party requiring a translation, and which, in turn, pays freelance translators to do the actual translating) and of direct hiring of a service provider (e.g., finding a translator via a website that enables searching for translators). In some cases, an agency may charge the service consumer a price for the service that is significantly greater than the amount paid to the service provider. In such cases, network-based service matching, by eliminating the need for such an agency, may enable payment by the service consumer to the service provider of a price that is lower than the price typically paid to an agency but higher than the amount typically received by the service provider, to the advantage of both parties. Typically, an agency may assign a service provider to a particular job without consulting the service consumer. On the other hand, network-based service matching, in accordance with some embodiments of the present invention, enables the service consumer to directly evaluate the suitability of each candidate service provider to render the service in accordance with the service consumer's requirements or preferences (e.g., with regard to price, delivery date, or quality).

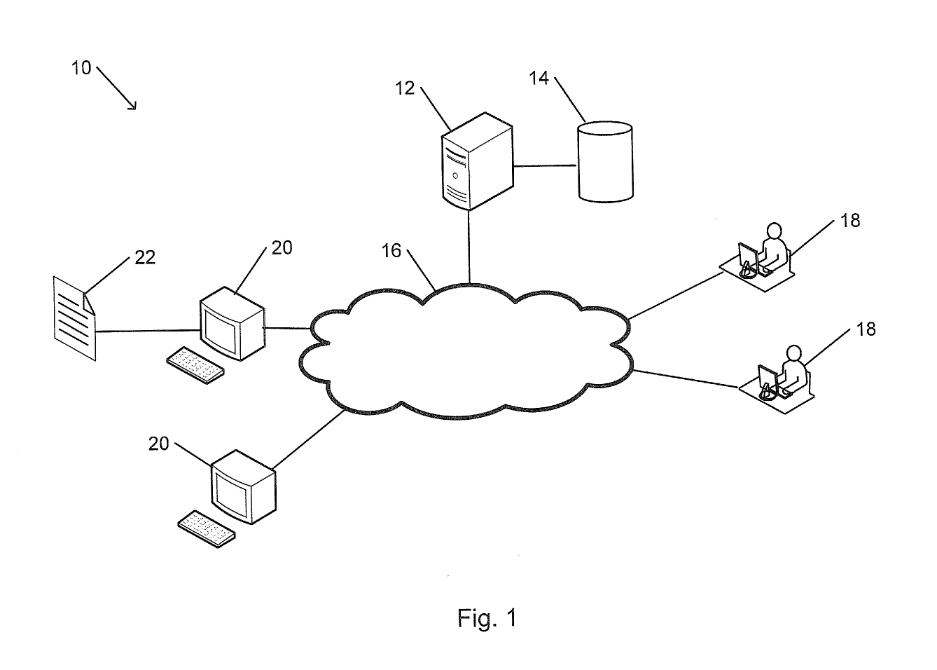

FIG. 1 schematically illustrates a system for network-based service matching, in accordance with an embodiment of the present invention.

Service matching system 10 is configured to identify one or more service providers 18 that may be candidates to provide a service to a service consumer 20.

Service matching server 12 is configured to communicate with service providers 18 (e.g., via one or a plurality of stationary or portable computers or terminals associated with each service provider 18) and service consumers 20 (e.g., via one or a plurality of stationary or portable computers or terminals associated with each service consumer 20) via network 16. For example, network 16 may include, for example, one or more of an internal network of an organization that includes service providers 18 and service consumers 20, the Internet, a telephone network, an entertainment network (e.g., cable or satellite), or another network that enables communication among various parties. Each service provider 18 may be registered with, or subscribe to, a network-based service matching organization. A service consumer 20 may subscribe to a network-based service matching organization, or may contact the network-based service matching organization as needed.

Service matching server 12 may represent one or more processors and associated devices at a single location, or several intercommunicating processors at separate locations. For example, the intercommunicating processors may intercommunicate via network 16 (e.g., distributed or cloud computing). Some or all functionality of service matching server 12 may be included in a processor associated with a service consumer 20 or with a service provider 18. For example, a device that is associated with service consumer 20 or with service provider 18 may have installed an application or program that enables direct access by that device to database 14. In this manner, service consumer 20 or service provider 18 may access the database without requiring processing by a remote processor of service matching server 12.

A service consumer 20 may seek a service provider 18 to provide a particular service. That service consumer 20 may communicate with service matching server 12 via network 16 to define the service requested. For example, service consumer 20 may provide a document 22 on which a language-related service is requested (e.g., translation, editing, or transcribing). Document 22 may be provided in an appropriate digital format (e.g., image, editable text, audio recording) for sending to service matching server 12 via network 16.

Service matching server 12 incorporates, or communicates with, service matching database 14. Information that is included in service matching database 14 may be gathered by direct solicitation of information from service providers 18, from service consumers 20, or both (e.g., using a questionnaire-like user interface). Alternatively or in addition, information that is included service matching database 14 may be gathered by monitoring operation or activities of, or communication between, service providers 18 and service consumers 20.

In accordance with some embodiments of the present invention, service matching system 10 may be configured to perform one or more tasks related to provision of a service by a service provider 18 to a service consumer 20. Such additional tasks may include, for example, handling billing and payment for services rendered, automatically offering promotional pricing (e.g., discount coupons, quantity discounts, rebates, or similar promotional pricing) to encourage a service consumer 20 to continue to solicit services via service matching system 10 or to encourage a new service consumer 20 to solicit services via service matching system 10, or sending notifications to a service consumer 20 regarding promotional pricing or other promotions on the part of one or more service providers 18.

Service matching system 10 may be configured to monitor progress in providing the service, e.g., by automatically monitoring additions to a product of the service (e.g., words, lines or pages in a text document of a product such as a translation, transcription, or computer program, or size of a file containing graphic output), or to monitor time spent in providing the service. For example, a service provider 18 may be required to periodically submit a current draft of a service product or to periodically check a current draft of the service product into a repository, or the service product may be automatically analyzed periodically. Results of such monitoring may be automatically analyzed so as to improve accuracy in predicting a delivery time of a rendered service to a current or future service consumer 20 (e.g., by calculating a rate or speed of progress or by monitoring availability of the service provider 18), or in automatically modifying a calculation of the amount of experience of the service 18. Service matching system 10 may automatically issue appropriate alerts if the progress in providing the service indicates failure or unlikelihood of the service being rendered by a target date or deadline.

Service matching system 10 may be configured to issue notifications to service providers 18 or to service consumers 20 when appropriate. For example, a service provider 18 may be informed when that service provider 18 was not selected to provide a service due to pricing or availability issues, thus enabling that service provider 18 to adapt to demands of the market.

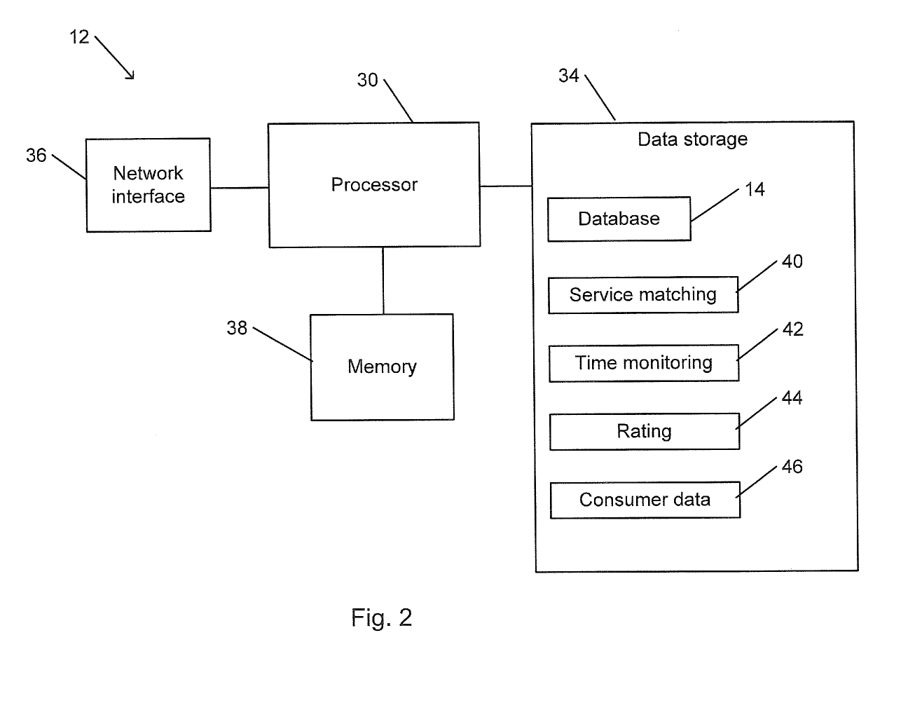

FIG. 2 schematically illustrates a server of a system for network-based service matching, in accordance with an embodiment of the present invention. In the following discussion, reference is also made to numbered items in FIG. 1.

Service matching server 12 includes processor 30. For example, processor 30 may include one or more processing units, e.g., of one or more computers. Processor 30 may be configured to operate in accordance with programmed instructions stored in memory 38. Processor 30 may be capable of executing an application for network-based service matching.

Processor 30 may communicate with another processor, e.g., that is associated with service provider 18 or service consumer 20, via network interface 36 and network 16. For example, output device 14 may include a computer monitor or screen.

Processor 30 may communicate with memory 38. Memory 38 may include one or more volatile or nonvolatile, memory devices. Memory 38 may be utilized to store, for example, programmed instructions for operation of processor 30, data or parameters for use by processor 30 during operation, or results of operation of processor 30.

Processor 30 may communicate with data storage device 34. Data storage device 34 may include one or more fixed or removable nonvolatile data storage devices. Data storage device 34 may be utilized to store, for example, programmed instructions for operation of processor 30, data or parameters for use by processor 30 during operation, or results of operation of processor 30. Data storage device 34 may be utilized to store database 14 or other data.

For example, data storage device 34 may include a computer readable medium for storing program instructions for operation of processor 30. In accordance with some embodiments of the present invention, the programmed instructions may take the form of service matching module 40 for performing network-based service matching. The programmed instructions may take the form of time monitoring module 42 for determining a time required by a service provider 18 to perform a defined service. The programmed instructions may take the form of rating module 42 for determining a rating that is provided by a service consumer 20 to a service that is provided by a service provider 18. Functionality of programmed instructions may be otherwise divided into modules.

Storage device 34 may be used to store service consumer data 46. Service consumer data 46 may include data that is provided by the service consumer when registering or subscribing to a network-based service matching organization, when first requesting service matching, or each time that service matching is requested. Information may include identifying information (e.g., name, customer identification number, business registration number, or other identifying information), billing address, billing means (e.g., credit card number or account number), contact infoimation, consumer preferences (with regard to services rendered via the network-based service matching system), or other relevant information.

It is noted that storage device 34 may be remote from processor 30. In such cases, storage device 34 may be a storage device of a remote server storing service matching module 40 in the form of an installation package or packages that can be downloaded and installed for execution by processor 30. Data storage device 34 may be utilized to store data or parameters for use by processor 30 during operation, or results of operation of processor 30.

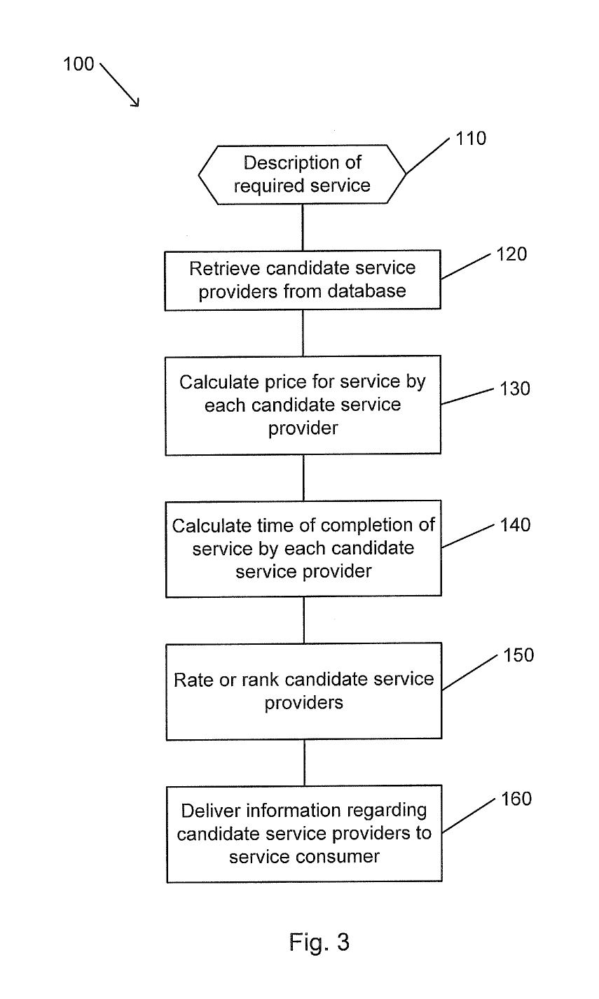

FIG. 3 is a flowchart depicting a method for network-based service matching, in accordance with an embodiment of the present invention.

It should be understood with respect to any flowchart referenced herein that the division of the illustrated method into discrete operations represented by blocks of the flowchart has been selected for convenience and clarity only. Alternative division of the illustrated method into discrete operations is possible with equivalent results. Such alternative division of the illustrated method into discrete operations should be understood as representing other embodiments of the illustrated method.

Similarly, it should be understood that, unless indicated otherwise, the illustrated order of execution of the operations represented by blocks of any flowchart referenced herein has been selected for convenience and clarity only. Operations of the illustrated method may be executed in an alternative order, or concurrently, with equivalent results. Such reordering of operations of the illustrated method should be understood as representing other embodiments of the illustrated method.

Service matching method 100 may be executed, for example, by a server of a network-based service matching system. Execution of service matching method 100 may be initiated by a service consumer. For example, execution of service matching method 100 may be initiated when a service consumer contacts the server, e.g., via a website that is associated with a network-based service matching organization. When contacting the server, the service consumer may indicate a request for the server to match the service consumer with one or more service providers. Alternatively or in addition, some or all operations of service matching method 100 may be executed by a processor that is associated with the service consumer or with one or more service providers.

Service matching method 100 is executed on the basis of a description of the service that is requested by the service consumer (block 110). The description of the requested service may be provided by the service consumer when requesting matching with a service provider. For example, the request may be submitted via a user interface that requires input of a description of the requested service. Alternatively or in addition, a description of the service may be obtained from the service consumer after the request was received. For example, the description of the requested service may indicate a type of service requested (e.g., where a serviced matching organization handles service matching requests for more than one type of service) and a time or date by which the service is to be completed. The description may, in some cases, include a price limitation or preference, such as a maximum price that the service consumer is willing or is able to pay for the requested service. The description may include information relevant to a particular type of service.

For example, in the case of a document for translation, the description may include a specification of the original language in which the document is written, and one or more target languages into which the document is to be translated. The text of the document, a detailed description of the document, or both, may be provided. As used herein, the description may be understood to include the text of the document itself, or a file (or pointer to a file) that includes the text of the document or an image of the text. A detailed description of the document may include a field of the subject matter of the document, a length of the document (e.g., number of words in the original language), an indication of level of difficulty (e.g., statistics regarding number of words per sentence or lengths of words), or other information relevant to service matching. Some or all relevant information regarding the text to be translated may be automatically derived from analysis of a provided document. For example, key words may be automatically detected to determine a subject matter of the document. An automatic count of pages, sentences, words, or characters may determine a size of the document.

The description may include specifying priorities in selection of a service provider. For example, a user interface of a service matching system may enable to prioritize or assign weights to various factors in selecting a service provider (e.g., price, availability or turnaround time, experience, rating by other service consumers, or other factors). Default priorities may be used when no such selection is made.

Candidate service providers that are determined to be capable of providing the requested service may be retrieved from a database (block 120). Each of the service providers in the database may be registered with a service matching organization. The database includes a list of service providers and information associated with each service provider. A service provider in the database may be identified as a candidate service provider when the associated information for that service provider conforms to criteria derived from the description of the requested service. In cases where complete conformation is not achievable (e.g., the associated information of no service provider meets all of the criteria), candidate service providers may be selected when some of the criteria are met (e.g., in accordance with predefined rules, weighting, or priorities). Selection criteria may be generally applicable, or may be customized to a particular service consumer or job.

Associated information in the database may be provided by each service provider when being included in the database (e.g., when registering with a network-based service matching organization for inclusion in the database). Information may be updated periodically. For example, registration with a network-based service matching organization may require periodic renewal. At the time of renewal, each service provider may be requested to review and update the information that is associated with that service provider (e.g., via a suitable user interface). Alternatively or in addition, the service provider may provide updated information when there is a change in the information. Some associated information may be entered or updated automatically. For example, a server may monitor performance of the service provider when providing services via the server (e.g., via a network-based service matching organization).

The selection of candidate service providers from the database may be based selection criteria. The selection criteria include the professional language transforming skills of the candidate service providers with respect to the described requested language transforming service. For example, when the requested service is translation of a document, professional language transforming skills are related to the translation that is requested. Required professional language transforming skills may include capability to translate from the original language of the document to the target language. Required professional language transforming skills may further include indication of familiarity with the subject matter of the document to be translated. Other criteria may include indication of capability to provide the translation by the required time (e.g., based on the length of the document and on a determined speed of translation for that service provider).

In some cases, no translator in the database meets all of the criteria. In this case, a translator may be selected as a candidate service provider when that translator conforms to a subset of the criteria (e.g., in accordance with predetermined priorities). For example, no translator in the database may be both capable of translating from the original language of the document to the target language and familiar with the subject matter of the document. In this case, a translator may be selected as a candidate service provider when that translator is capable of translation from the original language to the target language, but is not familiar with the exact field of the subject matter (e.g., is familiar with a related field). On the other hand, a translator who is familiar with the subject matter but not with the original or target language would not be selected as a candidate service provider.

A price for providing the requested service by each of the candidate service providers may be calculated (block 130). The information in the database that is associated with each service provider includes pricing information. For example, pricing information may include a unit price (e.g., per word, line, page, unit of time, or another suitable unit), surcharges, or discounts.

Calculating the price may include multiplying a unit price that is provided by each candidate service provider by a number of units. For example, in a language-related service, a price per word or page may be multiplied by a number of words or pages. The price may be adjusted by various surcharges or discounts. For example, a surcharge or discount may be indicated for various types of requested services (e.g., large or small jobs, rushed jobs, high- or low-priority jobs, difficult or easy jobs, busy or quiet seasons, or evening, weekend, or holiday work).

Calculating the price may involve additional considerations or calculations. For example, in the case of translation or transcription, a number of words in the final product may be estimated. In the case of translation or transcription, a unit price may refer to the number of words in the final translated document. A predetermined factor or formula may be applied to the document in the original language to estimate the number of characters, words, lines, or pages in the target language. In the case of transcription, a predetermined factor or formula may be applied to the speech that is to be transcribed (e.g., based on length of the speech or speed of delivery of the speech) to estimate the number of characters, words, lines, or pages in the final transcript.

The calculated price may represent a final price to which the service provider is committed. In this manner, both the service consumer and the service provider are aware of the final price prior to beginning the work.

A time or date of completion of the requested service by each candidate service provider may be calculated (block 140). The information in the database that is associated with each service provider includes information related to time required to perform the service. For example, time-related information may include a speed of performance of the service by that service provider (e.g., either as provided by the service provider or as derived from previous performance), time zone differences between the service provider and the service consumer, and information related to availability of that service provider to perform the service.

For example, a self-determined speed of performance may be provided by each service provider (e.g., translated or transcribed words, edited pages, or lines of source code per unit time, or another relevant rate). In addition, a speed, or an adjustment to a speed, may be determined from monitoring performance of each service provider when providing services (e.g., via a particular network-related service matching organization). For example, a time when the service provider begins a job and when the completed job is submitted may be monitored.

Times when a service provider is available to actively provide the service (e.g., work on the job) may be provided by each service provider. For example, the service provider may indicate regular working hours, or scheduled holidays or events during which the service provider does not expect to be available. In the case of short, urgent, or complex jobs (e.g., perhaps requiring extensive interaction between the service provider and the service consumer), a difference in time zones between the service provider and the service receiver may also be taken into account.

Each candidate service provider may be assigned a score or rank on the basis of a calculated suitability of that service provider to render the requested service in the manner required or requested (block 150). The score or rank may be based on information that is associated with the service provider and that is indicative of the suitability of the service provider to provide the requested service. Such a score or rank may be based on a subjective evaluation by previous recipients of similar services, or results of automatic tracking previous performance by that service provider (e.g., with regard to meeting deadlines or number of revisions required).

For example, rating of a quality of work of each service provider may be provided. The rating of a service provider may be based on feedback provided by service consumers that had previously utilized the services of that service provider. For example, upon completion of a provided service, the service consumer may be requested to indicate a degree of satisfaction with the rendered service, or with an aspect or component of the rendered service. A suitable analysis method (e.g., average or median score, deleting extreme or outlying values, or another statistical analysis technique) may be applied to create a final score. Other factors may be utilized in rating a service provider. For example, a rating of a service provider may take into account an amount of experience of the service provider in rendering a particular service (e.g., by monitoring services rendered via the network-based service matching organization, or otherwise, e.g., as provided by the service provider).

The score or rank may be based at least partially on priority criteria or weighting that had been indicated by the service consumer.

A list of the candidate service providers and associated information (including the calculated price and delivery times, plus any information related to suitability) are delivered via the network to the service consumer (block 160). The list is caused to be displayed, or otherwise presented (e.g., audibly) on a device to which the service consumer has access. The candidate service providers may be listed in an order that ranks the candidate service providers. For example, the candidate service providers may be listed in an order in accordance with service provider selection priorities that were indicated by the service consumer. In accordance with some embodiments of the present invention, each candidate service provider may be assigned an overall suitability score. For example, the suitability score may take into account such factors as price, availability, completion time, field of expertise, and a quality rating. The suitability score may be calculated by an algorithm that takes into account priorities that are set by the service consumer.

When the service consumer receives the list of candidate service providers, a user interface may enable the service consumer to interactively view the list. For example, the user interface may enable changing the listing order (e.g., by changing selection priorities or otherwise reordering the list). The user interface may enable the service consumer to interactively select which details of the information are to be displayed.

Concurrently with display of the list to the service consumer, each candidate service provider may also be informed of the requested service. For example, informing may include basic information regarding the service. Such basic infollnation may include a size of the job, a deadline for rendering the service, and a price. The service provider may then indicate an interest in providing the service, an availability to provide the service, or may be given the opportunity to modify the charged price.

The list that is displayed to the service consumer may be updated periodically (e.g., every 3 minutes or another suitable period) to reflect changes in status of the various candidate service providers. For example, the list may be modified in accordance with an indicated interest or disinterest, an indicated change in availability, or an indicated modification of the charged price. After a predetermined period of time, the displayed list may be made unavailable to the service consumer (without requesting the service again).

After reviewing the list, the service consumer may select one of the candidate service providers to render the requested service. The selection is received by a service matching server and is transmitted to the selected candidate service provider as a request to render the requested service. The request typically includes the subject matter of the requested service (e.g., a text to be translated or edited, a recording to be transcribed, a specification of an algorithm to be converted to programming code), the calculated price, and the date by which the service is to be rendered. Depending on circumstances (e.g., existence of confidentiality requirements or a need to abstain form conflicts of interest) the identity of the service consumer may or may not be revealed to the selected service provider. For example, the identity may be revealed only if the selected service provider indicates a need to know (e.g., in order to avoid a conflict of interest).

The selected service provider may accept or reject the request. In accordance with some embodiments of the present invention, the selected service provider may be enabled to request adjustments to the terms of the request (e.g., due to an aspect of the request that was not automatically detected). If the selected service provider does not indicate acceptance or rejection within a predetermined period of time (which may depend on the specific requirements of the requested service), the service consumer may be given the opportunity to select another service provider (or one may be automatically selected, subject to approval by the service consumer).

Until the selected serviced provider receives the request, no one other than the service consumer is aware of the need for the service and of the service matching process. Since the service matching process is automatic, no human observers or intervention is involved. Thus, neither the service providers nor any other party has access to details of any documents involved, or is aware that the service consumer requires the service.

In accordance with some embodiments of the present invention, some or all identifying information regarding the service providers may be hidden from service consumers. For example, each service provider may be identified solely by and identification number or code. Thus, any information that is not related to the capability of the service provider to render the service in the required manner or to the quality of the rendered service is hidden from the service provider (e.g., information that could lead to discrimination in a manner that is opposed to at least some local or national laws or customs).

Once the service provider has agreed to provide the service, both parties may be informed. The transaction may be assigned an identifying number or code. The service consumer may be asked to provide payment information or means (e.g., credit card number or account number), if these had not been previously provided. The provided payment means may be checked for validity or for authorization to pay the price of the requested service. The provided payment means may not be charged until completion of the service.

Concurrently, or at a later time, the other candidate service providers may be informed that another of the candidate service providers was selected. Each of the other candidate service providers may be provided with information that enables comparison of information regarding that service provider (e.g., availability, projected completion date, professional skills, charged price, or other relevant information) with that of the selected service provider. In this manner, each service provider may receive information that may be utilized to maintain competitiveness.

The service consumer may monitor progress in performance of the service. For example, a personal space may be set up to enable communication between the service consumer and the service provider. For example, the service provider may request clarification from the service consumer regarding terminology in a document to be translated or edited, to which the service consumer may respond.

When the service is completed, the service consumer is informed. The result of output of the service is sent to the service consumer via the network. The service consumer may examine the results. The service consumer may accept the results, or may send them back for further work (e.g., accompanied by comments). When requested or deemed necessary, a human evaluator (e.g., editor) associated with the network-based service matching organization may review the service product. Depending on the results of the review, the results may be sent back to the original service provider for additional work, or to a second service provider. Depending on the nature or results of the review, the service consumer may be required to pay an additional fee, or an amount may be deducted from the amount paid to the original service provider (e.g., to pay a second service provider). The service consumer may be enabled to score, rate, or otherwise provide an evaluation of performance by the service provider. Incentives may be offered to encourage consumer feedback, e.g., in the form of a discount for future services.

1. A method for matching one or more language transforming service providers to a consumer of a requested language transforming service, the method comprising:
receiving by a server via a communication network from the consumer a document for language transforming and a description of the requested language transforming service;
retrieving by the server from a database of a plurality of registered language transforming service providers one or a plurality of candidates for performing the language transforming service on the document, based on professional language transforming skills of each of the candidates with respect to the described requested language transforming service; and
causing the retrieved one or a plurality of candidates to be presented on a device of the consumer for selection by the consumer.

2. The method of claim 1, wherein the professional language transforming skills comprise a professional language transforming skill selected from a group of professional language transforming skills consisting of a language known, mother tongue, field of expertise, level of education, length of experience, quantity of experience, accuracy of results, and a rate of rendering the requested service.

3. The method of claim 1, wherein the requested service comprises translation of the document form an original language to a target language.

4. The method of claim 3, wherein retrieving from the database comprises retrieving those candidate service providers that are indicated in the database as being familiar with the original language, the target language, or a subject matter of the document.

5. The method of claim 1, wherein causing the retrieved one or a plurality of candidates to be presented on the device comprises causing to be presented a price for providing the requested service by a candidate of said one or a plurality of candidates.

6. The method of claim 5, wherein the price is calculated based on a number of characters, words, lines, or pages in text content of the document, or a length of audio content of the document.

7. The method of claim 5, wherein the price is calculated based on a discount or surcharge.

8. The method of claim 1, wherein causing the retrieved one or a plurality of candidates to be presented on the device comprises causing to be presented a projected time of completion of the service by a candidate of said one or a plurality of candidates.

9. The method of claim 8, wherein the projected time of completion is calculated using a speed of providing the service that is determined in accordance with monitored previous performance of the candidate.

10. The method of claim 8, wherein the projected time of completion is calculated in accordance with an availability of the candidate.

11. The method of claim 1, wherein causing the retrieved one or a plurality of candidates to be presented on the device comprises causing to be presented a score indicative of a suitability of a candidate of said one or a plurality of candidates to provide the requested service.

12. The method of claim 11, wherein the score is calculated in accordance with a rating of previous services that were provided by the candidate.

13. The method of claim 1, further comprising receiving from the consumer an indication of selection of a candidate of said one or a plurality of candidates to provide the requested service, sending the selected candidate a request to provide the requested service, and receiving from the selected candidate an agreement to or a rejection of the request.

14. The method of claim 13, further comprising monitoring progress in providing the requested service by the selected candidate.

15. The method of claim 13, further comprising soliciting from the consumer a rating of the provided service.

16. The method of claim 1, further comprising causing an indication of the requested service to be presented on a device of a candidate of said one or a plurality of candidates.

17. A system for matching one or more language transforming service providers to a consumer of a requested language transforming service, the system comprising:
a processor configured to communicate via a communication network with a device of the consumer, the processor in communication with a computer readable medium, wherein the computer readable medium contains a set of instructions wherein the processor is designed to carry out the set of instructions to:
receive from the device of the consumer a document for language transforming and a description of the requested language transforming service;
retrieve from a database of a plurality of registered language transforming service providers one or a plurality of candidates for performing the requested language transforming service on the document, based on professional language transforming skills of each of the candidates with respect to the described requested language transforming service; and
cause the retrieved one or a plurality of candidates to be presented on the device of the consumer for selection by the consumer.

18. The system of claim 17, wherein the processor is further configured to communicate via the communication network with a device of each of said one or a plurality of candidates, and is further designed to carry out the set of instructions to:
receive from the device of the consumer an indication of selection of a candidate of said one or a plurality of candidates to provide the requested service;
send the device of the selected candidate a request to provide the requested service;
receive from the device of the selected candidate an agreement to or a rejection of the request;
monitor progress in providing the requested service by the selected candidate;
solicit from the device of the consumer a rating of the provided service; and
cause an indication of the requested service to be presented on the device of each candidate of said one or a plurality of candidates.

19. The system of claim 17, wherein the instructions to cause the retrieved one or a plurality of candidates to be presented on the device comprise causing to be presented a price for providing the requested service by a candidate of said one or a plurality of candidates, a projected time of completion of the service by a candidate of said one or a plurality of candidates, or a score indicative of a suitability of a candidate of said one or a plurality of candidates to provide the requested service.

20. The system of claim 17, wherein the professional language transforming skills comprise a professional language transforming skill selected from a group of professional language transforming skills consisting of a language known, mother tongue, field of expertise, level of education, length of experience, quantity of experience, accuracy of results, and a rate of rendering the requested service.
